(19) United States
(12) Patent Application Publication
(10) Pub. No.: US 2009/0308937 A1
(43) Pub. Date: Dec. 17, 2009

(54) NONCONTACT DATA COMMUNICATIONS DEVICE

(75) Inventors: Hideki Yagi, Kanagawa (JP); Akira Mito, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/480,073

(22) Filed: Jun. 8, 2009

(30) Foreign Application Priority Data
Jun. 13, 2008 (JP) 2008-155743

(51) Int. Cl. G06K 19/06

(52) U.S. Cl. 235/492

(57) ABSTRACT

An IC card includes: a rectifying circuit; a register section in which a plurality of setpoints related to the output voltage of the rectifying circuit are set; a voltage level detecting circuit configured to detect the output voltage level of the rectifying circuit on the basis of the setpoints set in the register section; a plurality of transistors for load modulation to be made valid or invalid according to the output voltage level detected by the voltage level detecting circuit; and a control section configured to generate transmission data according to reception data received by a receiving section and supply the transmission data to the plurality of transistors for load modulation.

### CROSS-REFERENCE TO RELATED APPLICATION

This application is based upon and claims the benefit of priority from the prior Japanese Patent Application No. 2008-155743 filed in Japan on Jun. 13, 2008; the entire contents of which are incorporated herein by reference.

### BACKGROUND OF THE INVENTION

1. Field of the Invention

The present invention relates to a noncontact data communications device.

2. Description of Related Art

In recent years, noncontact data communications devices, such as a noncontact IC card and an RFID tag, have become widely popular. Some noncontact IC cards do not have a power supply in the devices themselves. In the case of a noncontact IC card or the like having no power supply in the device itself, an electric current is flowed through a transmitting coil serving as the antenna of a reader/writer to generate a magnetic field. By utilizing the magnetic field, a voltage, i.e., an induction voltage is generated in the receiving coil of the noncontact IC card or the like to use the voltage as a source of power.

In general, however, the intensity of the magnetic field received by the receiving coil of the noncontact IC card or the like decreases and, therefore, the induction voltage also decreases as a distance between the reader/writer and the noncontact IC card increases.

If the induction voltage decreases, a large amount of power is consumed at a resistor or resistors related to load modulation. Consequently, electric power necessary to drive a transmitting circuit and the like is no longer available, thus possibly disabling communication with the reader/writer.

Hence, in order to solve such problems as described above, Japanese Patent Application Laid-Open Publication No. 2007-288718, for example, proposes a terminal in which an induction voltage is detected to change a load according to the value of the detected induction voltage. Thus, electric power consumed at the load is adjusted so as to vary the strength of load modulation. As a result, it is possible to prevent communication from being disabled by adjusting power consumption according to the magnitude of the induction voltage.

In the proposal, however, the strength of load modulation is varied only in a uniform manner according to the induction voltage. Specifically, power consumption is adjusted only in a predetermined pattern. Consequently, it is not possible to obtain an appropriate strength of load modulation, depending on a difference in communication environment, thus resulting in an inability to perform communication in some cases.

The communication environment of a noncontact card or the like differs depending on the type of reader/writer to which the noncontact card or the like is applied, on a difference in a method of letting the noncontact card or the like face the reader/writer, or on the structure and form of an IC card, a tag or a terminal on which the circuit section of the communication device of the noncontact card is mounted. Since such a difference in the communication environment is not taken into consideration in the above-described proposal, communication with the reader/writer is disabled in some cases.

### BRIEF SUMMARY OF THE INVENTION

According to one aspect of the present invention, it is possible to provide a noncontact data communications device includes: a rectifying circuit; a register circuit in which one or more setpoints related to the output voltage of the rectifying circuit are set; a voltage level detecting circuit configured to detect the output voltage level of the rectifying circuit on the basis of the one or more setpoints set in the register circuit; a plurality of transistors for load modulation to be made valid or invalid according to the output voltage level detected by the voltage level detecting circuit; a receiving circuit configured to operate on the output voltage of the rectifying circuit and receive data; and a control circuit configured to generate transmission data according to reception data received by the receiving circuit and supply the transmission data to the plurality of transistors for load modulation.

### BRIEF DESCRIPTION OF THE DRAWINGS

FIG. 1 is a block diagram illustrating a communications system 1 configured with a reader/writer and an information processing terminal in accordance with a first embodiment of the present invention;

FIG. 2 is a block diagram illustrating a configuration example of an IC card in accordance with the first embodiment of the present invention;

FIG. 3 is a schematic view used to explain a relationship between the output voltage of a rectifying circuit and setpoints in accordance with the first embodiment of the present invention;

FIG. 4 is a block diagram illustrating a configuration example of a voltage level detecting circuit in accordance with the first embodiment of the present invention;

FIG. 5 is a tabular view used to explain the operation (valid or invalid) of each buffer circuit in accordance with the first embodiment of the present invention; and

FIG. 6 is a block diagram illustrating a configuration example of an IC card in accordance with a second embodiment of the present invention.

### DETAILED DESCRIPTION OF THE EMBODIMENTS OF THE INVENTION

Hereinafter, embodiments of the present invention will be described with reference to the accompanying drawings.

### First Embodiment

### (Configuration)

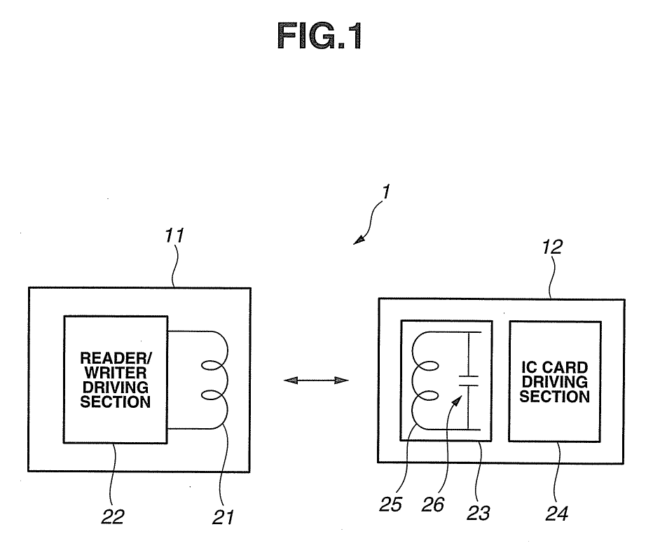

First, the configuration of a communications system in accordance with the present embodiment will be explained according to FIG. 1. FIG. 1 is a block diagram illustrating a communications system 1 configured with a reader/writer and an information processing terminal. Hereinafter, an explanation will be made by taking an example in which the information processing terminal is an IC card.

A reader/writer 11 has a transmitting coil 21 serving as a transmitting/receiving antenna and a reader/writer driving section 22. The reader/writer 11 has a signal processing section, a transmitting section and a receiving section, though not shown in the figure, and is connected to a host computer.

An IC card 12 has a data transmitting/receiving section 23 and an IC card driving section 24. The data transmitting/receiving section 23 is composed of a receiving coil 25 configured to receive a carrier wave and a tuning capacitor 26. The data transmitting/receiving section 23 is a resonance circuit configured to resonate at a specific frequency. The configuration of the IC card driving section 24 will be described later.

The reader/writer 11 generates a magnetic field by flowing an electric current through the transmitting coil 21. The reader/writer 11 recognizes a change in the electric current flowing through the transmitting coil according to load modulation in the IC card 12 as a response from the IC card 12, and performs predetermined processes. The predetermined processes include, for example, operations in conjunction with a host computer (not shown in the figure). The IC card 12 varies the impedance thereof with respect to the reader/writer 11 by making a load provided within the card valid or invalid, thereby performing load modulation.

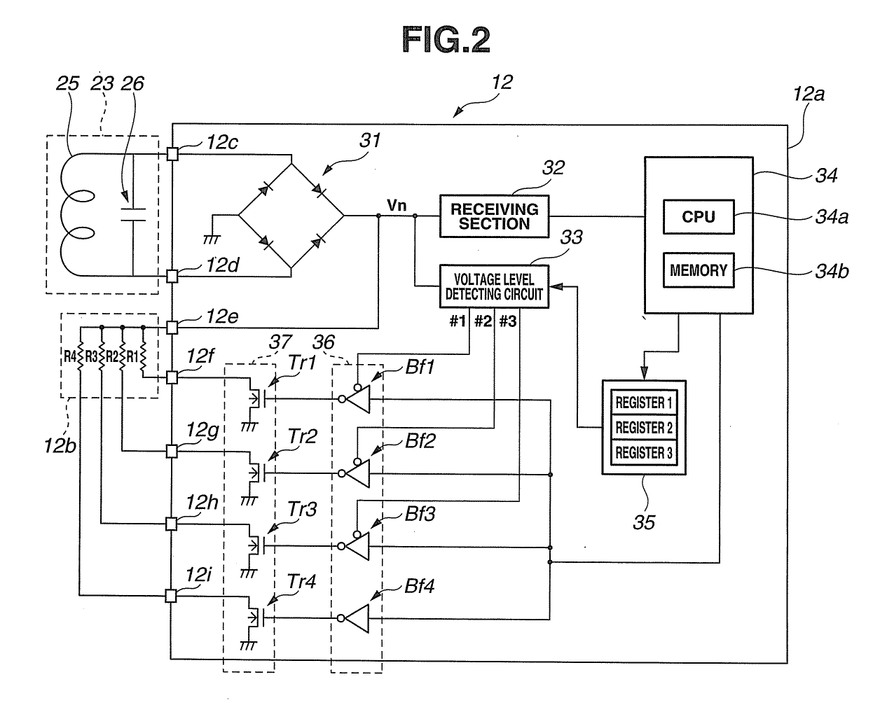

FIG. 2 is a block diagram illustrating a configuration example of the IC card 12.

The IC card 12 has a data transmitting/receiving section 23 including a receiving coil 25 and a capacitor 26. In FIG. 2, the rest of the IC card other than the data transmitting/receiving section 23 corresponds to the IC card driving section 24 of FIG. 1.

The IC card 12 includes a semiconductor chip 12a in which various circuits mounted on an unillustrated substrate are built, and a resistor group 12b provided on the substrate and external to the semiconductor chip 12a as a plurality of impedance elements for load modulation.

The semiconductor chip 12a includes a rectifying circuit 31, a receiving section 32, a voltage level detecting circuit 33, a control section 34, a register section 35, a switch section 36, and a transistor section 37.

The rectifying circuit 31 is a diode bridge circuit for rectification connected across the parallel-connected receiving coil 25 and capacitor 26 through the terminals 12c and 12d of the semiconductor chip 12a. The rectifying circuit 31 rectifies a voltage developed across the transmitting coil 25 and outputs a DC voltage. The output voltage Vn of the rectifying circuit 31 is supplied to various circuits as a source of driving power within the IC card 12.

The receiving section 32 operates on the output voltage Vn of the rectifying circuit 31 and is a receiving circuit configured to receive and extract reception data contained in the output voltage Vn.

The output voltage Vn of the rectifying circuit 31 and a setpoint from the register section 35 are input to the voltage level detecting circuit 33. The voltage level detecting circuit 33 is configured to monitor the output voltage Vn of the rectifying circuit 31 and detect, on the basis of a plurality of setpoints set in the register circuit 35, at which level, among a plurality of preset levels, the output voltage Vn is. The voltage level detecting circuit 33 outputs a plurality of detection signals, which are three detection signals #1 to #3 here, according to the level of the output voltage Vn. The detection signals #1 to #3 of the voltage level detecting circuit 33 are input to the switch section 36. The configuration of the voltage level detecting circuit will be described later.

The control section 34 includes a central processing unit (hereinafter referred to as the CPU) 34a, a memory 34b which is a nonvolatile memory, and a RAM (not shown in the figure). The control section 34 is a control circuit configured to perform a predetermined process appropriate for reception data from the receiving section 32, and generates transmission data. The nonvolatile memory 34b stores data on later-described respective setpoints TH1 to TH3. The control section 34 outputs the transmission data generated according to the reception data to the transistor section 37 through the switch section 36 as a serial signal.

The register section 35 is a register circuit including a plurality of registers, which are three registers here, in which data on one or more setpoints related to the output voltage Vn of the rectifying circuit 31 is set. The data on the respective setpoints set in the register section 35 is reconfigurable. As will be described later, the data on the respective setpoints is set as the result of being read out of the memory 34b by the control section 34 and written to the register section 35. The data on the respective setpoints set in the register section 35 is supplied to the voltage level detecting circuit 33.

The switch section 36 has a plurality of buffer circuits, which are four buffer circuits Bf1 to Bf4 here. Transmission data from the control section 34 and the detection signals #1 to #3 from the voltage level detecting circuit 33 are input to the switch section 36. The detection signals #1 to #3 are respectively input to the buffer circuits Bf1 to Bf3 as enable signals. The respective buffer circuits Bf1 to Bf3 are enabled to come into operation when detection signals provided as the enable signals are at a LOW level, and invert and output an input transmission data signal to the transistor section 37. The transmission data of the control section 34 is input to the input ends of all of the buffer circuits Bf1 to Bf4. Note that an enable signal is not input to the buffer circuit Bf4. Alternatively, the buffer circuit Bf4 always inverts the input transmission data signal and outputs the signal as is to the transistor section 37.

The transistor section 37 has a plurality of transistors, which are four NMOS transistors Tr1 to Tr4 here, as transistors for load modulation. The transmission data signals of the four buffer circuits Bf1 to Bf4 of the switch section 36 are respectively input to the four gates of the four NMOS transistors (hereinafter simply referred to as transistors) Tr1 to Tr4. The source sides of the respective transistors Tr are grounded.

The transistor section 37 is composed of a plurality of transistors for load modulation which are made valid or invalid as the result that the outputs of the respective buffers of the switch section 36 are controlled on the basis of the detection signals #1 to #3 from the voltage level detecting circuit 33. In other words, the transistor section 37 is a plurality of transistors for load modulation which are made valid or invalid, along with the external resistor group, according to an output voltage level detected by the voltage level detecting circuit 33.

The resistor group 12b is provided external to the semiconductor chip 12a, as described above, and includes a plurality of resistors R1 to R4 as a group of impedance elements for load modulation. One end of each resistor R is common-connected to the terminal 12e of the semiconductor chip 12a.

The drain sides of the transistors Tr1 to Tr4 are respectively connected to the other ends of the plurality of resistors R1 to R4 through the terminals 12f to 12i of the semiconductor chip 12a. In this way, the IC card 12 has a plurality of open-drain terminals for load modulation.

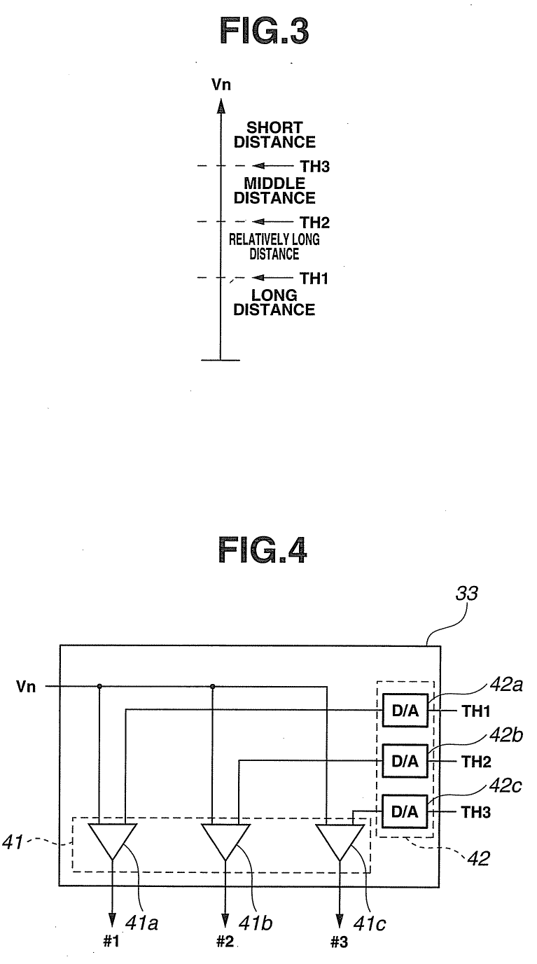

FIG. 3 is a schematic view used to explain a relationship between the output voltage Vn of the rectifying circuit 31 and setpoints.

The level of the output voltage Vn of the rectifying circuit 31 varies according to a distance between the reader/writer 11 and the IC card 12. A determination is made as to at which level or within which range, among a plurality of preset levels, the output voltage Vn is. The determination of the level or the range is made based on comparison between each setpoint of the register section 35 and the output voltage Vn of the rectifying circuit 31.

As illustrated in FIG. 2, the register section 35 has three registers 1, 2 and 3. A setpoint TH1 is preset in the register 1, a setpoint TH2 is preset in the register 2, and a setpoint TH3 is preset in the register 3. For example, the setpoint TH1 is 5 V, the setpoint TH2 is 7 V, and the setpoint TH3 is 9 V.

As shown in FIG. 3, the output voltage Vn is classified into four levels or ranges according to the respective setpoints TH set in the register section 35. Thus, a determination is made as to at which level the output voltage Vn that has been input is. The level or range is correlated with a distance L between the IC card 12 and the reader/writer 11. If a setpoint TH changes, then a position or a width for the level or range is also changed.

Here, if the output voltage Vn is smaller than the setpoint TH1, then the distance L between the IC card 12 and the reader/writer 11 is regarded as being large, i.e., a long distance. If the output voltage Vn is equal to or larger than the setpoint TH1 but smaller than the setpoint TH2, then the distance L between the IC card 12 and the reader/writer 11 is regarded as being relatively large, i.e., a relatively long distance. If the output voltage Vn is equal to or larger than the setpoint TH2 but smaller than the setpoint TH3, then the distance L between the IC card 12 and the reader/writer 11 is regarded as being moderate, i.e., a middle distance. If the output voltage Vn is larger than the setpoint TH3, then the distance L between the IC card 12 and the reader/writer 11 is regarded as being small, i.e., a short distance.

Note that although in the present embodiment, the plurality of ranges is defined as four ranges, there may be no more than three ranges or may be five or more ranges.

FIG. 4 is a block diagram illustrating a configuration example of the voltage level detecting circuit 33. The voltage level detecting circuit 33 is configured by including a comparison section 41 and a digital-to-analog conversion (hereinafter abbreviated as D/A) section 42. The comparison section 41 has three comparing circuits 41a, 41b and 41c. The D/A section 42 has D/A circuits 42a, 42b and 42c. Each comparing circuit compares the output voltage Vn with a corresponding setpoint and outputs a detection signal as a comparison result.

Data on the setpoint TH1 set in the register 1 is input to the D/A circuit 42a, so as to be converted to an analog value, and is then input to one input end of the comparing circuit 41a. The output voltage Vn is input to the other input end of the comparing circuit 41a. Likewise, data on the setpoint TH2 set in the register 2 is input to the D/A circuit 42b, and data on the setpoint TH3 set in the register 3 is input to the D/A circuit 42c. The output voltage Vn is input to the other input ends of the respective comparing circuits 41b and 41c.

Each comparing circuit outputs a HIGH level if the output voltage Vn is equal to or larger than each setpoint TH. If the output voltage Vn is smaller than the setpoint TH1, then none of the comparing circuits outputs a detection signal. Thus, the detection signals #1 to #3 go to a LOW level. If the output voltage Vn is equal to or larger than the setpoint TH1 but smaller than the setpoint TH2, then the comparing circuit 41a outputs the detection signal #1. Thus, the detection signal #1 goes to a HIGH level and the detection signals #2 and #3 go to a LOW level. If the output voltage Vn is equal to or larger than the setpoint TH2 but smaller than the setpoint TH3, then the comparing circuit 41b also outputs the detection signal #2. Thus, the detection signals #1 and #2 go to a HIGH level and the detection signal #3 goes to a LOW level. If the output voltage Vn is equal to or larger than the setpoint TH3, then the comparing circuit 41c also outputs the detection signal #3. Thus, the detection signals #1 to #3 go to a HIGH level.

### (Operation)

Next, an explanation will be made of the operation of the IC card 12 according to the above-described configuration.

First, the IC card 12 generates an induction voltage therewithin when brought close to the reader/writer 11.

When an induction voltage is generated and respective circuits within the IC card 12 become enabled, a CPU 34a first executes initial processes including a default setting process. In the default setting process, the CPU 34a reads data on the respective setpoints TH1 to TH3 stored in a nonvolatile memory 34b, and stores the data in the corresponding registers of the register section 35, respectively.

The voltage level detecting circuit 33 compares the output voltage Vn of the rectifying circuit 31 with the respective setpoints TH input from the register section 35, and outputs the above-described detection signals #1 to #3.

For example, if the distance L between the reader/writer 11 and the IC card 12 is a short distance, all of the detection signals #1 to #3 go to a HIGH level. Thus, all of the buffer circuits Bf1 to Bf3 output a LOW level. As a result, only the buffer circuit Bf4 is enabled, thereby inverting transmission data from the control section 34 and outputting the data to the transistor Tr4. The transistor Tr4 turns on or off according to the transmission data. When the transistor Tr4 turns on, an electric current flows through the resistor R4. Since impedance with respect to the reader/writer 11 at that time depends solely on the resistor R4, power consumption results in a value corresponding to the impedance.

On the other hand, the CPU 34a executes a process of generating transmission data appropriate for reception data from the receiving section 32. The CPU 34a outputs the generated transmission data to each buffer circuit Bf of the switch section 36 as a serial signal.

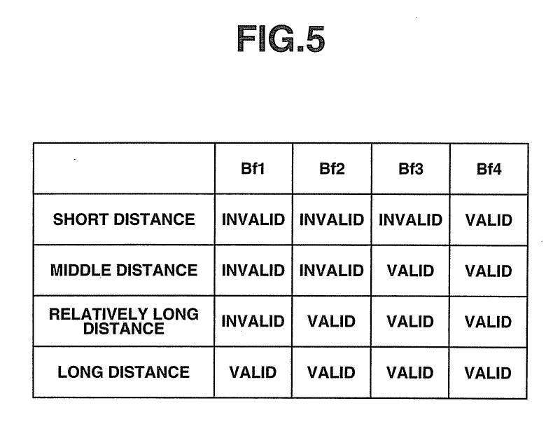

Note that FIG. 5 is a tabular view used to explain a relationship between the distance L and the operation (valid or invalid) of each buffer circuit. If the distance L is a short distance, the buffer circuits Bf1 to Bf3 are in a disabled state, i.e., invalid. Thus, the transistors Tr1 to Tr3 other than the transistor Tr4 are made invalid and neither turn on nor turn off in response to the transmission data.

If the distance L between the reader/writer 11 and the IC card 12 is a middle distance, then the detection signals #1 and #2 go to a HIGH level and the detection signal #3 goes to a LOW level. Thus, the buffer circuits Bf1 and Bf2 are made invalid and output a LOW level. As a result, the buffer circuits Bf3 and Bf4 are made valid and enabled and, when the transistors Tr3 and Tr4 are made valid and turned on as shown in FIG. 5, electric currents flow through the resistors R3 and R4. Since impedance with respect to the reader/writer 11 at that time depends solely on the resistors R3 and R4, power consumption results in a value corresponding to the impedance. However, since the respective resistors of the resistor group 12b are parallel-connected, the impedance is lower, compared with that in a case where the distance L is a short distance. Accordingly, a variation in the impedance as viewed from the reader/writer 11 does not become too small.

If the distance L between the reader/writer 11 and the IC card 12 is a relatively long distance, then the detection signal #1 goes to a HIGH level and the detection signals #2 and #3 go to a LOW level. Thus, the buffer circuit Bf1 is made invalid and outputs a LOW level. As a result, the buffer circuits Bf2, Bf3 and Bf4 are made valid and enabled and, when the transistors Tr2, Tr3 and Tr4 are made valid and turn on as shown in FIG. 5, electric currents flow through the resistor R2, R3 and R4. Since impedance with respect to the reader/writer 11 at that time depends solely on the resistors R2, R3 and R4, power consumption results in a value corresponding to the impedance. However, since the respective resistors of the resistor group 12b are parallel-connected, the impedance becomes even smaller, compared with that in a case where the distance L is a middle distance. Accordingly, a variation in the impedance as viewed from the reader/writer 11 does not become too small.

In addition, if the distance L between the reader/writer 11 and the IC card 12 is a long distance, then none of the detection signals #1 to #3 goes to a HIGH level. Thus, all of the buffer circuits Bf1 to Bf4 are made valid and enabled and, when all of the transistors Tr1 to Tr4 are made valid and turn on as shown in FIG. 5, electric currents flow through all of the resistors R1 to R4. Since impedance with respect to the reader/writer 11 at that time depends on the resistors R1 to R4, power consumption results in a value corresponding to the impedance. However, since the respective resistors of the resistor group 12b are parallel-connected, the impedance becomes even smaller, compared with that in a case where the distance L is a relatively long distance. Accordingly, a variation in the impedance as viewed from the reader/writer 11 does not become too small.

As described above, according to the IC card of the present embodiment, it is possible to set setpoints used to detect the level of the output voltage Vn in the register section according to a communication environment. Consequently, it is possible to obtain an appropriate strength of load modulation.

### Second Embodiment

In the first embodiment, the resistor group 12 having a plurality of resistors is used as a group of impedance elements for load modulation. The present embodiment differs from the first embodiment in that impedance elements other than resistors are also used.

By selecting and utilizing not only resistors but also various impedance elements according to a communication environment, it is possible to match or approximate a waveform of variation in the strength of load modulation to the optimum shape. In other words, by utilizing various impedance elements, it is possible to improve the quality of a signal waveform detected on the reader/writer side.

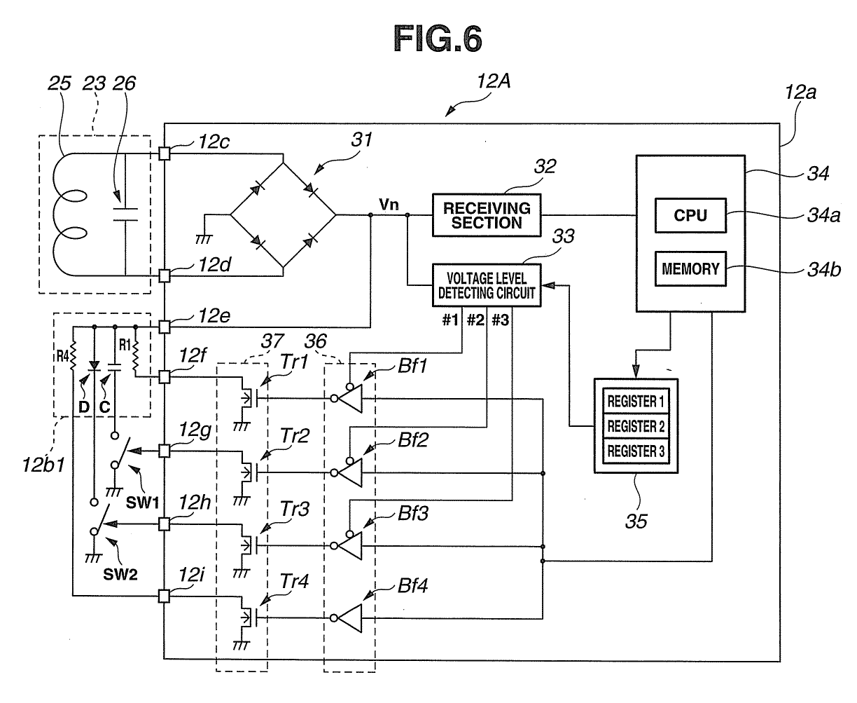

FIG. 6 is a block diagram illustrating a configuration example of an IC card 12A in accordance with the present embodiment. Note that the same components as those of FIG. 2 are denoted by like reference symbols or numerals and will not be explained again. Thus, an explanation will be made mainly of differences from the first embodiment.

As illustrated in FIG. 6, an impedance element group 12b1 has a capacitor C, which is a capacitive element, in place of the resistor R2 which is a resistive element, and a diode D in place of the resistor R3. Consequently, when a transistor Tr2 turns on, an electric current flows through the capacitor C and, when a transistor Tr3 turns on, an electric current flows also through the diode D.

In FIG. 6, the transistor Tr2 is configured so that an electric current is flowed through the capacitor C by turning on a switch SW1. Likewise, the transistor Tr3 is configured so that an electric current is flowed through the diode D by turning on a switch SW2. Note that these switches SW1 and SW2 may be excluded from the configuration.

As described above, according to the IC card of the present embodiment, advantageous effects are provided in addition to those of the first embodiment. That is, by using capacitors and the like other than resistors, it is possible to adapt a waveform of variation in the strength of load modulation, or the like, to a more appropriate shape according to a communication environment, for example, the type of reader/writer, the structure of the IC card and the like.

Also as described above, according to the IC card of the present embodiment, it is possible to set setpoints used to detect the level of the output voltage Vn in the register section according to a communication environment. Accordingly, it is possible to obtain an appropriate strength of load modulation. That is, by selecting an impedance element as appropriate, it is possible to cause a variation in the strength of load modulation appropriate for the communication environment. Thus, it is possible to prevent communication from being disabled.

Also as described above, according to the IC cards of the above-described two embodiments, it is possible to set setpoints used to detect the level of the output voltage Vn in the register section according to a communication environment. Accordingly, it is possible to obtain an appropriate strength of load modulation.

Consequently, according to the noncontact data communications devices of the above-described two embodiments, it is possible to obtain an appropriate strength of load modulation according to a difference in the communication environment.

Note that in the above-described two embodiments, only one impedance element is connected to the drain side of each transistor. Alternatively, a plurality of various impedance elements may be connected in series or in parallel with the respective transistors. Still alternatively, the impedance elements may be connected using a combination of these connection modes.

In addition, although in the above-described two embodiments, an explanation has been made by taking an IC card as an example, the noncontact data communications device may be other devices, such as an RFID tag.

It is to be understood that the present invention is not limited to the above-described embodiments, but the embodiments may be modified or altered in various other ways to the extent of not changing the subject matter of the present invention.

What is claimed is:

1. A noncontact data communications device comprising:
a rectifying circuit;
a register circuit in which one or more setpoints related to the output voltage of the rectifying circuit are set;
a voltage level detecting circuit configured to detect the output voltage level of the rectifying circuit on the basis of the one or more setpoints set in the register circuit;
a plurality of transistors for load modulation to be made valid or invalid according to the output voltage level detected by the voltage level detecting circuit;
a receiving circuit configured to operate on the output voltage of the rectifying circuit and receive data; and
a control circuit configured to generate transmission data according to reception data received by the receiving circuit and supply the transmission data to the plurality of transistors for load modulation.

2. The noncontact data communications device according to claim 1, wherein the one or more setpoints set in the register circuit are reconfigurable.

3. The noncontact data communications device according to claim 2, wherein the one or more setpoints set in the register circuit are set by the control circuit.

4. The noncontact data communications device according to claim 3, wherein the control circuit has a nonvolatile memory in which the one or more setpoints have been previously stored, and is configured to set the one or more setpoints by reading the one or more setpoints stored in the nonvolatile memory and writing the one or more setpoints to the register circuit.

5. The noncontact data communications device according to claim 1, wherein the voltage level detecting circuit outputs a plurality of detection signals corresponding to the output voltage level.

6. The noncontact data communications device according to claim 5, wherein the voltage level detecting circuit has one or more comparing circuits configured to compare the respective setpoints from the register circuit with the output voltage of the rectifying circuit, and the respective comparing circuits output detection signals corresponding to the respective setpoints.

7. The noncontact data communications device according to claim 6, wherein the voltage level detecting circuit includes one or more digital-to-analog converters associated respectively with the one or more comparing circuits and configured to convert the respective setpoints from the register circuit to analog values, and the one or more comparing circuits compare the outputs of the one or more digital-to-analog converters with the output voltage level.

8. The noncontact data communications device according to claim 1, comprising a plurality of buffer circuits provided in correspondence with the plurality of transistors for load modulation, wherein the transmission data from the control circuit is input to the respective buffer circuits so that the buffer circuits output the transmission data to corresponding transistors for load modulation, and the validation or invalidation is executed by controlling the output of the transmission data from the respective buffer circuits to the corresponding transistors for load modulation.

9. The noncontact data communications device according to claim 8, wherein the voltage level detecting circuit outputs a plurality of detection signals corresponding to the output voltage level, and the respective detection signals are supplied to corresponding buffer circuits as enable signals used to control the output of the transmission data.

10. The noncontact data communications device according to claim 9, wherein the voltage level detecting circuit has one or more comparing circuits configured to compare respective setpoints from the register circuit with the output voltage of the rectifying circuit, and the respective comparing circuits output detection signals corresponding to the respective setpoints.

11. The noncontact data communications device according to claim 1, further comprising a plurality of impedance elements for load modulation on the output sides of the plurality of transistors for load modulation.

12. The noncontact data communications device according to claim 11, wherein the plurality of impedance elements for load modulation includes a plurality of resistive elements.

13. The noncontact data communications device according to claim 11, wherein the plurality of impedance elements for load modulation includes at least two of a resistive element, a capacitive element and a diode.

14. The noncontact data communications device according to claim 10, wherein the rectifying circuit, the register circuit, the voltage level detecting circuit, the plurality of transistors for load modulation, the receiving circuit, and the control circuit are formed within a semiconductor chip, and the plurality of impedance elements for load modulation is provided external to the semiconductor chip.

15. The noncontact data communications device according to claim 1, wherein the noncontact data communications device is an IC card.

16. The noncontact data communications device according to claim 14, further comprising a plurality of impedance elements for load modulation on the output sides of the plurality of transistors for load modulation.

17. The noncontact data communications device according to claim 16, wherein the rectifying circuit, the register circuit, the voltage level detecting circuit, the plurality of transistors for load modulation, the receiving circuit, and the control circuit are formed within a semiconductor chip, and the plurality of impedance elements for load modulation is provided external to the semiconductor chip.

18. The noncontact data communications device according to claim 1, wherein the noncontact data communications device is an RFID tag.

19. The noncontact data communications device according to claim 18, further comprising a plurality of impedance elements for load modulation on the output sides of the plurality of transistors for load modulation.

20. The noncontact data communications device according to claim 19, wherein the rectifying circuit, the register circuit, the voltage level detecting circuit, the plurality of transistors for load modulation, the receiving circuit, and the control circuit are formed within a semiconductor chip, and the plurality of impedance elements for load modulation is provided external to the semiconductor chip.
